(19) United States
(12) Patent Application Publication
(10) Pub. No.: US 2008/0037742 A1
(43) Pub. Date: Feb. 14, 2008

(54) VOICE OVER INTERNET PROTOCOL PAYPHONE DIAL TONE SERVICE SYSTEM

(76) Inventor: Edward W. Greenberg, San Jose, CA (US)

Correspondence Address: Edward W Greenberg, 1600 Stokes St Apt 24, San Jose, CA, 95126, US

(21) Appl. No.: 11/697,714

(22) Filed: Apr. 7, 2007

Related U.S. Application Data
(60) Provisional application No. 60/802,470, filed on May 22, 2006.

(51) Int. Cl. H04M 17/00

(52) U.S. Cl. 379/143

(57) ABSTRACT

The Payphone Dial Tone Service System receives control and communication data via a VoIP communication connection that originates at an Analog Terminal Adapter and modem connected to the smart payphone. The Analog Terminal Adapter and modem communicate exclusively with the Payphone Dial Tone Service System of the Payphone Dial Tone Service Provider and transmit a unique code to identify the smart payphone. The Payphone Dial Tone Service System validates the smart payphone and originates an Internet-based communication session to the appropriate carrier or Public Switched Telephone Network gateway. The Payphone Dial Tone Service System also manages the ANI data to ensure proper terminal identification and AMA billing.

### CROSS-REFERENCE TO RELATED APPLICATIONS

This application is a Non-Provisional of Provisional (35 USC 119(e)) Application No. 60/802,470 filed on May 22, 2006.

### FIELD OF THE INVENTION

This invention relates to pay telephones (“payphones”) and, in particular, to a broadband-based dial tone product for “smart” payphones that uses Voice over Internet Protocol (VoIP) as the communication paradigm.

### BACKGROUND OF THE INVENTION

It is a problem in the field of smart payphones that they are presently not served by VoIP communication connections. Therefore, “smart” payphones must rely on an analog phone line provided by a traditional phone company that is no different from a typical business or residential phone line (a POTS line, for “plain old telephone service”).

In the mid-1980s, the U.S. Federal Communications Commission issued an order that allowed subscribers to provide telephone service to the public via payphones that were connected to the Public-Switched Telephone Network (PSTN). Until that time, most, if not all, telephone companies only allowed their own payphones to be connected to the telephone network. Telephone company-owned payphones required dedicated phone lines and special telephone switching equipment to count the coins deposited into the payphones, rate phone calls, and collect or return the coins depending on whether a call was answered or not. In contrast, “smart” payphones have on-board computers and other equipment that enable them to perform the same functions as standard payphones without needing the centralized control equipment and a special line from the phone company. Thus, the combination of the development of smart payphones and the FCC order allowing them to be connected to telephone networks ushered in the era of competition in the payphone marketplace by companies termed “Payphone Service Providers” (PSPs).

When smart payphones were first deployed, they were attached to an analog telephone line that was provided by a traditional phone company. This analog telephone line was no different from a typical business or residential phone line (a POTS line). This dedicated analog telephone line was given a special name, such as COPT line or PAL to enable the phone company to manage this line in a manner that differed from residential or business telephone lines. Traditional phone companies, ILECs, were authorized to charge higher rates for COPT telephone lines than they charged business customers. However, the COPT telephone line only performed the same functions as the POTS analog telephone line and simply provided the payphone with dial tone, local calling, access to Long Distance carriers, and access to OSPs, but had third party billing blocked. Thus, these special telephone lines were more expensive than required for the services provided.

In the 1990s, there was a tremendous growth in toll free (800) calls from payphones. Many of these calls were to prepaid calling card platforms that allowed payphone users to avoid either depositing coins or using the OSP that served the payphone and that would normally pay a commission to the PSP for each call originated from the payphone. Thus, PSPs were forced to carry calls for which they received no compensation, from either the calling party or the OSP. These toll free calls are termed “dial around” calls, since they are placed without activating a call billing function for the PSP. In 1996, pursuant to a Congressional Act, the FCC required that Long Distance carriers compensate PSPs for each and every completed 800 call and access code call where the calling party directly accessed a selected long distance carrier. This payment scheme is called “dial around compensation” (DAC).

In order to implement this requirement, the FCC ordered Payphone Dial Tone Service Provider Local Exchange Companies serving PSPs to transmit special information digits, called “ANIii” or “Flex-ANI” from the payphone to the Long Distance carrier. The digits non-LEC PSPs use are either “70”, to signal an ordinary pay telephone, or “29” to signal a payphone used by inmates in a jail or prison. Code “70” identifies a telephone line that serves a payphone that does not use the LEC network-provided coin control signaling, and this code is transmitted from the originating end office as part of the call signaling on all calls made from these telephone lines. It is critically important to PSPs that their payphones transmit ANii digits, since DAC has grown to be a substantial percentage of a PSPs' revenues, perhaps as much as one-third. Moreover, the “70” coding digits help prevent payphone fraud by alerting OSPs that a call is from a payphone, and these calls cannot be billed to the originating phone line. The “29” coding digits help prevent correctional inmates from making improper calls, such as to judges, prosecutors, or crime victims. Thus, the deployment of the Flex-ANI protocol provided COPT lines and PAL with special characteristics that made them different from ordinary telephone lines.

Recently, communication companies began to deploy interconnect devices that allow ordinary telephones to be connected to broadband (BB) Ethernet networks. These interconnect devices allow people to conduct voice telephone calls over the Internet, and this service is termed “Voice over Internet Protocol” (VoIP). Some communication companies also offer a “gateway” service that allows VoIP users to have their calls terminated on the PSTN. Thus, VoIP users could call every working telephone number that could be accessed via the PSTN, not just other VoIP users. The basic functioning of a VoIP telephone connection is similar to a telephone line, although VoIP service is limited in a number of ways that make it unsuitable for providing PAL or COPT service to PSPs.

In particular, for every call that originates at a Local Exchange Carrier or Competitive Local Exchange Carrier switch, an Automatic Message Accounting (AMA) record is generated and appended to the voice call. This AMA record travels with the voice call as it makes its way through the network connections that comprise the call connection to the called party's LEC switch. The AMA record is recognized by the Long Distance carrier switch once the voice call enters the Long Distance carrier network. Some Inter-Exchange carriers use billing software that looks for payphone identification data (the “70” Flex ANI digits) in the AMA record and copies part of the appended AMA record into the billing database to identify calls that are eligible for DAC. However, the VoIP service digitizes the entirety of the analog voice call and breaks the voice call into a sequence of data packets that are transmitted through the Internet. The paths taken by the various data packets differs, and this set of data packets is assembled at the distant end into the data file that represents the digitized voice communication generated by the calling party. As the voice data is digitized, the AMA data must be maintained and also the FLEX ANI digits recognized during transmission.

A further problem is the provision of E911 service, since the IP address assigned to a VoIP call does not correspond to a physical address of the calling party. The VoIP call must self-identify the physical location of the calling party so that emergency service agencies can respond to that location even if the calling party is unable to communicate this information. These critical characteristics of a voice call cannot be supported by existing VoIP services.

### BRIEF SUMMARY OF THE INVENTION

The above-described problems are solved and a technical advance achieved by the present Voice over Internet Protocol Payphone Service System (termed “VoIP Payphone Dial Tone Service System” herein) which enables smart payphones to access VoIP communication services to implement the call connection.

Providing telephone service as a VoIP communication connection offers numerous advantages over traditional telephone service. The advantages stem mostly from the greater efficiencies of IP networks that provide the VoIP transmission capability. As telephone users increasingly transition to VoIP, the advantages are magnified because fewer digital to analog conversions are needed and fewer carriers need to be compensated. The greater efficiency of VoIP immediately translates into lower costs. In particular, Payphone Dial Tone Service Providers are able to provide dial tone in many locations for a single line at a lower cost than the ILEC charges for a single line. The cost of providing service plummets for additional lines that are provisioned at the same location, because multiple lines can share the same Analog Terminal Adapter (ATA), broadband modem, and Internet connection, thereby amortizing the cost of this equipment and network access over multiple lines. Payphone Dial Tone Service Providers also deliver calls to their OSP over the Internet. By avoiding all long distance charges between the smart payphone and the OSP platform, the OSP pays a greater commission to the Payphone Dial Tone Service Provider and the smart payphone owner. The savings on international calls are particularly dramatic due to the significant cost of POTS or PSTN long distance service in these jurisdictions.

These advantages are provided by the Payphone Dial Tone Service System. At the customer premises, the Payphone Dial Tone Service Provider installs the smart payphone, which uses a Network Interface Device (NID) to interconnect the smart payphone to the telephone line that serves these premises. The NID is wired to an ATA, and the ATA provides dial tone to the smart payphone. The ATA also provides enough line current to power most smart payphones and charge their batteries. The ATA emulates the signaling of an Incumbent Local Exchange Company POTS line, so that the smart payphone can operate normally, without modifications, the same as if it were attached to an Incumbent Local Exchange Company telephone line.

In order to provide communication service to the smart payphone, the ATA must be connected to a broadband Internet connection. The ATA typically is connected to a broadband modem, such as a digital subscriber line (DSL) modem, a cable modem, or other high-capacity, IP-based, Ethernet network interface. Since this broadband modem may provide transmission capacity in excess of that required for the smart payphone, the broadband modem may also serve a plurality of smart payphones as well as normal analog business phones or other terminal devices, such as Point-Of-Sale terminals. The ATA communicates with a Payphone Dial Tone Service Provider's Payphone Dial Tone Service System and carries calls via the public Internet using connections provided by an Internet Service Provider (ISP). Payphone Dial Tone Service System uses commercially available software and customer programming to switch calls from the smart payphone to the appropriate carrier or PSTN gateway and provides or supports all the features and functions that are necessary for a smart payphone to operate as it is intended and to comply with all laws and government regulations. In addition, the Payphone Dial Tone Service System is equipped with an IP switch and associated control software and can optionally split the data from the control signaling, so the media data packets are directly transmitted from the ATA to the called party, while the control data is directed to the Payphone Dial Tone Service Provider's Payphone Dial Tone Service System. This ensures that the Payphone Dial Tone Service System maintains control of the call connection, but does not have to process the generated media data packets.

### BRIEF DESCRIPTION OF THE DRAWINGS

FIG. 1 illustrates, in block diagram form, the overall architecture of the present Payphone Dial Tone Service System;

FIG. 2 illustrates, in flow diagram form, the operational steps taken by the present Payphone Dial Tone Service System to place a call to a called party from a smart payphone;

FIG. 3 illustrates, in block diagram form, the overall architecture of the present Payphone Dial Tone Service System, with a single Analog Terminal Adapter serving multiple devices;

FIG. 4 illustrates, in block diagram form, the overall architecture of the present Payphone Dial Tone Service System equipped to provide E911 service; and

FIG. 5 illustrates, in flow diagram form, the operational steps taken by the present Payphone Dial Tone Service System to place a call to an E911 service from a smart payphone.

### DETAILED DESCRIPTION OF THE INVENTION

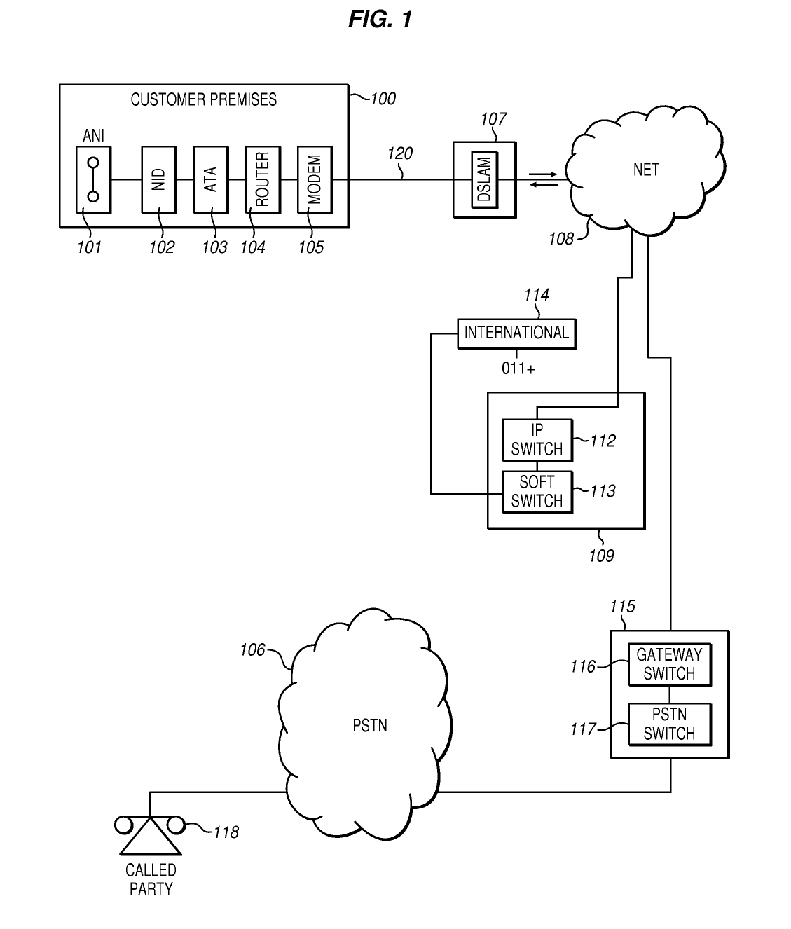

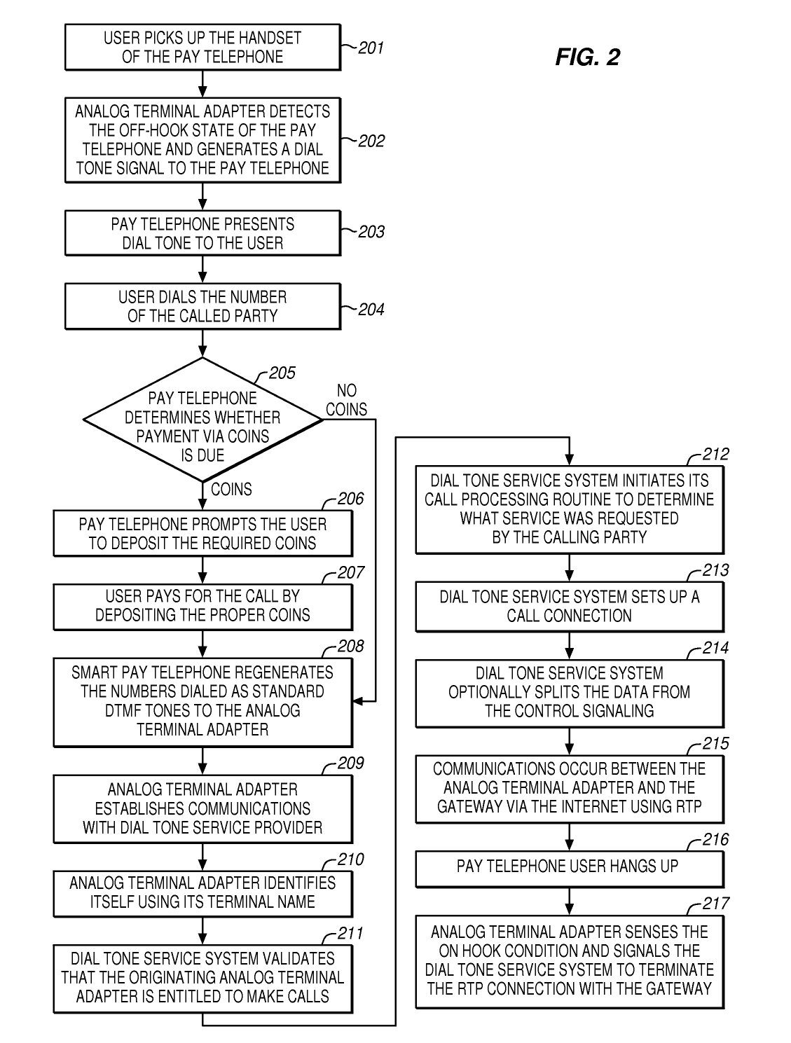

FIG. 1 illustrates, in block diagram form, the overall architecture of the present Payphone Dial Tone Service System, and FIG. 2 illustrates, in flow diagram form, the operational steps taken by the Payphone Dial Tone Service System to place a call to a called party from a smart payphone.

### System Architecture for the Payphone Dial Tone Service System

At the customer premises 100 where the Payphone Dial Tone Service Provider has installed the payphone 101, a Network Interface Device (NID) 102 is installed to interconnect the payphone 102 to the telephone line 120 that serves these premises. The Payphone Dial Tone Service Provider typically either plugs the smart payphone 101 into the NID 102 or hardwires the payphone 101 to the NID 102 using a punch down block or screw down terminals. The side of the NID 102 that the Payphone Dial Tone Service Provider attaches to is called the customer side. The other side of the NID 102 is called the network side. The network side of the NID 102 is wired to another device, an Analog Terminal Adapter (ATA) 103, which emulates the signaling of an Incumbent Local Exchange Company POTS line, so that the smart payphone can operate normally, without modifications, the same as if it were attached to an Incumbent Local Exchange Company telephone line. In order to provide communication service to the smart payphone, the ATA 103 must be connected to a broadband Internet connection. The ATA typically is connected to a broadband modem 105 via a router 104. The modem 105 and router 104 may be combined into a single piece of equipment that performs both functions. The broadband modem 105 is connected via a broadband connection to the Internet 120.

The ATA 103 is programmed to communicate initially only with a particular Payphone Dial Tone Service System 109 and originates calls via the public Internet 108 using connections provided by an Internet Service Provider (ISP) 107 only to that particular Payphone Dial Tone Service System 109. The call connection is extended through the Internet 108 by the Internet Service Provider 107 to the particular Payphone Dial Tone Service System 109 where it is received in an Ethernet switch and VoIP softswitch. The softswitch 113 uses commercially available software and custom programming to manage the calls received over the IP switch 112 from the payphone 101 and switches these calls to the appropriate carrier or PSTN gateway 115 and over the PSTN 106 to the called party 118. In addition, the softswitch 113 and its control software optionally can split the data from the control signaling, so the media data packets are directly transmitted from the ATA 103 to the gateway switch 116, while the control data is directed to the softswitch 113. This ensures that the softswitch 113 maintains control of the call connection, but does not have to process the generated media data packets.

### Call Origination in the Payphone Dial Tone Service System

An illustration of the operation of the Payphone Dial Tone Service System of FIG. 1 can be provided by tracing the processing of a call origination from the smart payphone 101 to the called party 118, as illustrated in the flow chart of FIG. 2. All calls start with the user picking up the handset (off hook) of the smart payphone 101 at step 201. When the smart payphone 101 goes off hook, the ATA 103 detects the off-hook state of smart payphone 101 at step 202 and generates a dial tone signal which is transmitted to the smart payphone 101 and presented to the user at step 203. The user then dials the number of the called party 118 at step 204. The processing of a local toll call or a direct dialed long distance call are substantially the same, so no distinction is made in this description between these calls; the primary difference is that the local toll call is switched via the LEC switches of the PSTN, while the long distance call is transmitted via the Long Distance carrier from the LEC to a LEC that serves the called party.

Upon completion of dialing, if payment via coins is due, as determined at step 205, the smart payphone 101 prompts the user to deposit the required coins at step 206. Once the user pays for the call by depositing the proper coins at step 207, or if the call does not require deposit of coins, then the smart payphone 101 regenerates the numbers dialed at step 208, emitting standard DTMF tones to the ATA 103. The ATA 103, in response to the received DTMF tones, establishes communications with Payphone Dial Tone Service System 109 at step 209 using a Session Initiation Protocol (SIP). The ATA 103 identifies itself at step 210 using its terminal name, which is typically a 10-digit number that corresponds to an assigned telephone number.

The initial SIP communication session with the Payphone Dial Tone Service System 109 provides the Payphone Dial Tone Service System 109 with the identity of the ATA 103 originating the call and the telephone number that the payphone user dialed (terminating number). In the PSTN 106, originating and terminating numbers are called “ANIs”, for Automatic Number Identification. The switching and signaling systems in the PSTN 106 include these numbers so that switches can connect the calls properly and so that billing systems can record information needed to bill the calls to the billed party. In the PSTN 106, when a call is handed off from one carrier to another carrier, the originating carrier provides the originating and terminating ANIs. This is called the “ANI Stream.” In addition to the 10-digit telephone number, the originating ANI is preceded by two additional digits called identification digits, or ANhii.

The SIP communication session provides the Payphone Dial Tone Service System 109 with the equivalent of originating and terminating ANIs in a digital format, rather than analog tones that the PSTN 106 uses. For all calls, the Payphone Dial Tone Service System 109 first validates that the originating ATA 103 is entitled to make calls at step 211. For example, it checks its database to make sure the Payphone Dial Tone Service System 109 connected to the ATA 103 is a current customer and has not terminated service. Next, the softswitch 113 at step 212 initiates its call processing routine to determine what service was requested by the calling party at the smart payphone 101. The requested service can be a local call, long distance call, call to an E911 service agency, International call, etc. In this example, the call is a call over the PSTN 106 to the called party at called telephone 118. Thus, the softswitch 113 sets up a call connection at step 213 through the IP switch 112 via the Internet 108 to a gateway that is provided by a third party vendor 115 and thence to the PSTN 106. Again, this call connection is set up using SIP. Once the call connection is set up, the communications occur between the ATA 103 to the gateway via the Internet 108 using RTP, or another real-time transport protocol at step 215. The gateway provider converts the call back to analog and terminates it using the PSTN 106 and standard PSTN signaling. PSTN signals, such as audible ring tones and busy signals, are transmitted back to the gateway switch 116 and from the gateway via the Internet 108 and the softswitch 113 to the ATA 103 and the smart payphone 101. Thus, from the payphone user's perspective, the call functions as a POTS call.

In addition, the softswitch 113 and associated control software at step 214 optionally can split the data from the control signaling, so the media data packets are directly transmitted from the ATA 103 to the gateway switch 116, while the control data is directed to the softswitch 113. This ensures that the softswitch 113 maintains control of the call connection, but does not have to process the generated media data packets.

When the payphone user hangs up (on hook) on the local call at step 216, the ATA 103 senses the on-hook condition and signals the Payphone Dial Tone Service System 109 to terminate the RTP connection with the gateway and the softswitch 113 at step 217.

### Multiple Devices Served by a Single Analog Terminal Adapter

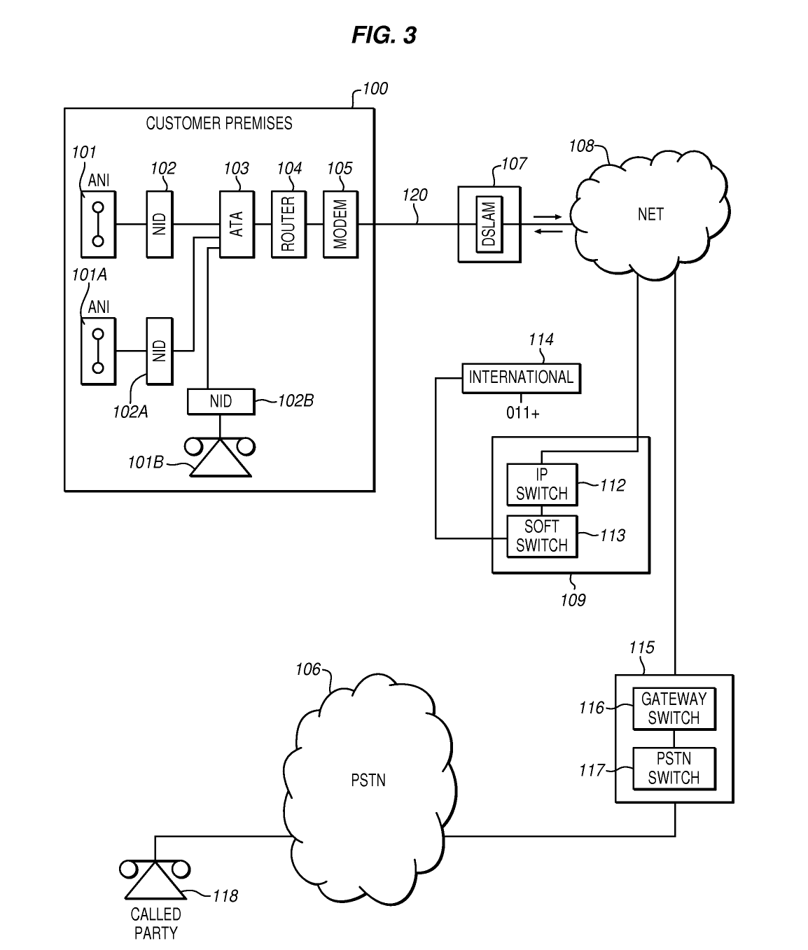

FIG. 3 illustrates, in block diagram form, the overall architecture of the present Payphone Dial Tone Service System 109, with a single ATA 103 serving multiple devices. As shown in the system architecture of FIG. 1, a smart payphone 101 is served by an ATA 103. The ATA 103 is a broadband device and typically is equipped to serve a plurality of input channels. A single smart payphone 101 is shown in FIG. 1 as exclusively connected to the ATA 103, but it is possible to interconnect a plurality of devices to the ATA 103, such as: smart payphones and/or single line telephones, and/or other terminal devices, such as: credit card terminals, security systems, or other data collection devices. FIG. 3 illustrates a typical configuration of such equipment, including two smart payphones 101, 101A and a single line telephone 101B concurrently connected to the ATA 103. Each channel of the ATA 103 is login and password protected to ensure that the equipment connected thereto is authorized by the Payphone Dial Tone Service System 109.

Payphone Dial Tone Service Providers, therefore, may benefit from marketing business line service to their smart payphone owners, since the provisioning of additional lines at a payphone site has very low costs, creating a tremendous opportunity for commissions and profits for both the customer and the Payphone Dial Tone Service Provider. Furthermore, the Payphone Dial Tone Service Provider and its customers may also offer Internet access. Sites could be equipped with wi-fi antennas with small equipment investments and almost no incremental network costs. This could lead to additional revenues from individual users, municipalities, utilities, and cellular companies (who are developing wi-fi capable handsets).

### Interconnection to Emergency Service Providers

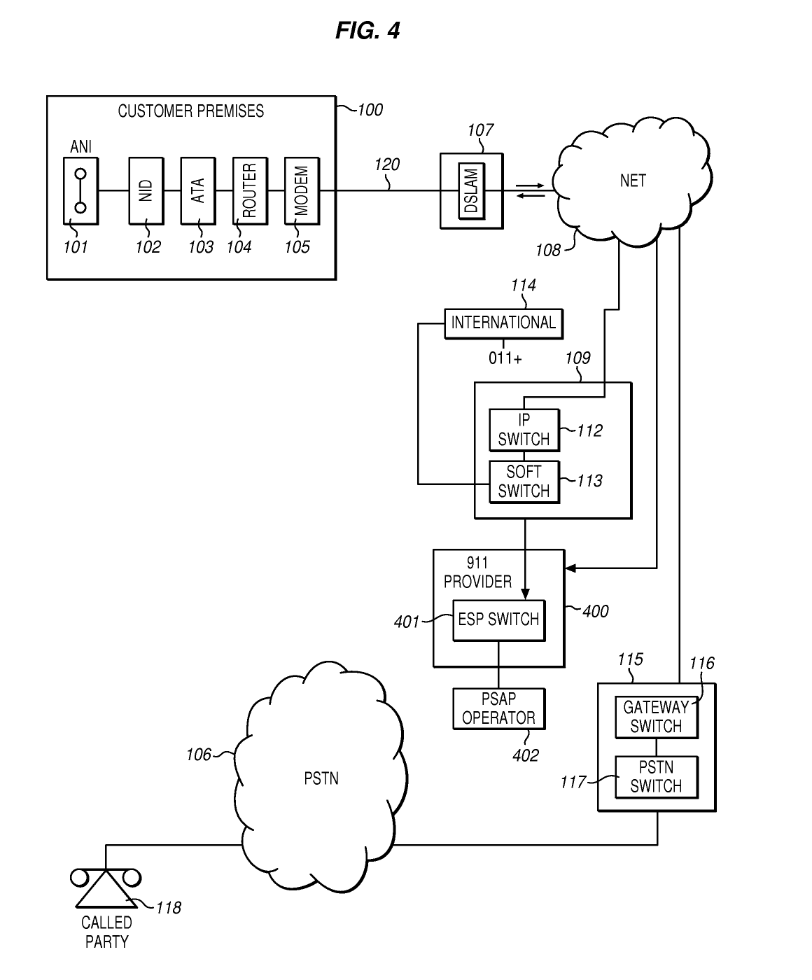

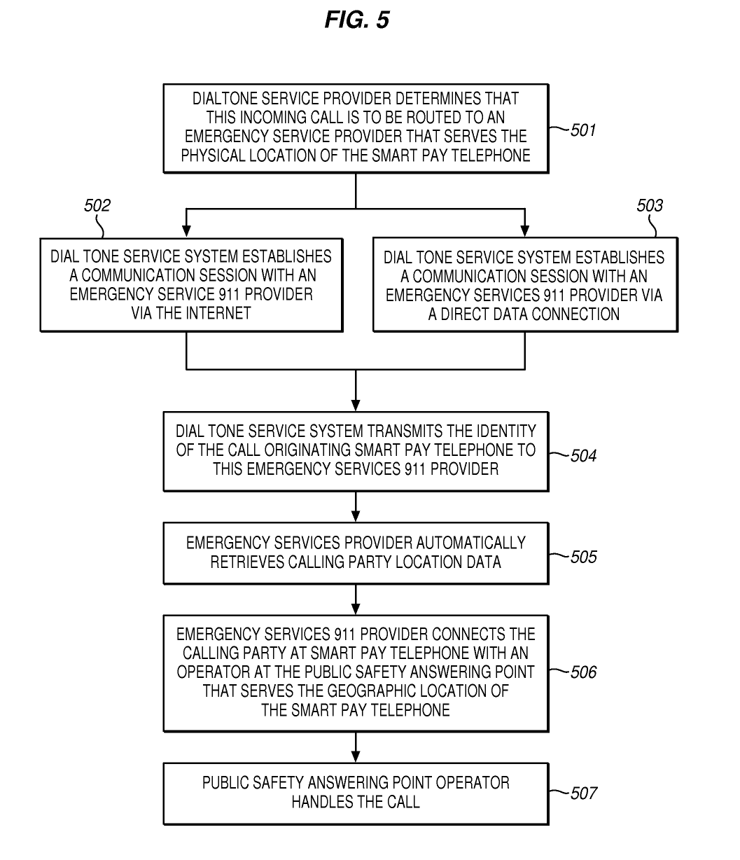

FIG. 4 illustrates, in block diagram form, the overall architecture of the present Payphone Dial Tone Service System 109 equipped to provide E911 service, and FIG. 5 illustrates, in flow diagram form, the operational steps taken by the present Payphone Dial Tone Service System 109 to place a call to an E911 service provider 400 from a smart payphone 101.

The initiation of a call connection from a smart payphone 101 to an emergency service provider 400 is similar to that described above with respect to a toll call. However, the call to an emergency service provider 400 is a toll free call and there is no billing associated with this call connection. Therefore, the smart payphone 101 recognizes the dialed digits as being representative of a call origination to a toll free emergency services number and does not request the payment for this call from the calling party. The ANI data includes the dialed number and at step 212 in FIG. 2 (shown in FIG. 4 as step 501), the Payphone Dial Tone Service System 109 determines that this incoming call is to be routed to an emergency service provider 400 that serves the physical location of the smart payphone 101. The Payphone Dial Tone Service System 109 establishes a communication session with an emergency service provider 400 either via the Internet at step 502 or via a direct data connection at step 503 and transmits the identity of the call originating smart payphone 101 to the emergency services provider 400 at step 504 over this communication session. The emergency services provider 400 typically is pre-provisioned with data that identifies a correspondence between the identity of the smart payphone 101, using its ANI, and its physical location and can, at step 505, automatically retrieve this location data from the database. At step 506, the emergency services provider 400 connects the calling party at smart payphone 101 via Emergency Service Provider (ESP) Switch 401 with an operator at the Public Safety Answering Point (PSAP) 402 that serves the geographic location of the smart payphone 101, and the PSAP operator, at step 507, handles the call.

### Operator Assisted Dialed Local or Long Distance (0+)

The user dials “0” and then a ten-digit local or long distance number. On completion of dialing, smart payphone 101 regenerates the numbers dialed, emitting standard DTMF tones to the ATA 103. The ATA 103 then establishes communications with the Payphone Dial Tone Service System 109 using SIP. The call is validated and then the call is delivered to a third party OSP over the Internet using SIP to set up the call. The Payphone Dial Tone Service System 109 selects one of several OSPs, depending on the routing of the call. The OSP obtains billing information from the payphone user (credit card, collect, billed to third number) and then terminates the call via the PSTN 106.

### Operator Assisted not Dialed Local or Long Distance (0−)

The user dials “0”. After a preset period of time, the smart payphone 101 regenerates the 0, emitting standard DTMF tones to the ATA 103. The ATA 103 then establishes communications with the Payphone Dial Tone Service System 109 using SIP. The call is validated and then the call is delivered to a third party OSP's mechanized or live operator platform over the internet using SIP to set up the call and RTP to allow the communications between the operator and the payphone user. The OSP determines the type of call the payphone user wishes to make (collect, person to person, etc.), obtains billing information from the payphone user (credit card, collect, billed to third number), and then extends the call via the PSTN 106 to the called party.

### Long Distance Provider Access Codes

In the case where the calling party selects a particular Long Distance carrier to serve their call origination, the calling party first dials a Long Distance carrier access code, then the number of the called party. Thus, the calling party dials “1010XXX” or “950-XXXX” to identify this type of call, where the XXX or XXXX identifies the Long Distance carrier (for example, 1010ATT=1010288). On completion of dialing, smart payphone regenerates the numbers dialed, emitting standard DTMF tones to the ATA 103. The ATA 103 then establishes a communication session with the Payphone Dial Tone Service System 109 using SIP. The call is validated and then the call is delivered to a gateway provider 115 over the Internet using SIP to set up the call. Importantly, the Payphone Dial Tone Service System 109 is capable of signaling the gateway provider 115 whether or not the call is from a payphone (for payphone calls only, not calls from other phones that may be served by the same ATA and access line 120) by providing control data that identifies the calling party as a smart payphone.

There are four methods of doing this:
SIP header: A special header is added to the SIP INVITE packet that carries the info-digits: “X-InfoDigits: 70”. This method allows the Payphone Dial Tone Service Provider to identify 70, 29, and even 07 digits.
Adding info digits to CID: The info digits would be prepended or appended to the ANI, for example, from: “Payphone”<709252150525>. This method allows the Payphone Dial Tone Service Provider to identify 70, 29, and even 07 digits.

Distinct Endpoint: Calls from pay phones are sent to a distinct IP address: Calls from non-pay phones are sent to another IP address. One end-point is needed for each info-digit code to be supported.
Registered ANI: All pay phone ANIs are registered with the terminating provider. Each payphone is registered with the correct info-digits. Calls from unregistered (non-payphone) ANIs are handled as 00.

This causes the gateway provider to insert the ANii digits in the ANI stream to identify this call as a smart payphone originated call before handing the call off to the caller's selected carrier. In addition to allowing tracking of calls for payment of DAC, this prevents fraudulent calls by alerting the operator not to allow calls to be charged to the originating ANI because it is a payphone. After inserting the ANIii digits, the gateway provider delivers the call to the Long Distance carrier selected by the calling party (as indicated by the 1010XXX number dialed) over the PSTN, as described above.

### 800 Provider Access Codes

In the case where the calling party dials a “toll free” number, such as 800, 888, 877, etc., on completion of dialing, smart payphone regenerates the numbers dialed, emitting standard DTMF tones to the ATA 103. The ATA 103 then establishes a communication session with the Payphone Dial Tone Service System 109 using SIP. The call is validated and then the call is delivered to a gateway provider over the Internet using SIP to set up the call. Importantly, the Payphone Dial Tone Service System 109 is capable of signaling the gateway provider whether or not the call is from a payphone (for payphone calls only, not calls from other phones that may be served by the same ATA and access line 120) by providing control data that identifies the calling party as a smart payphone. This causes the gateway provider to insert the ANii digits in the ANI stream to identify this call as a payphone-originated call before handing the call off to the 800 subscriber's selected carrier, which alerts the 800 carrier that DAC is due for the call. After inserting the ANii digits, the gateway provider delivers the call to the 800 Long Distance carrier selected by the called party over the PSTN, as described above.

### Polling of Smart Payphones

A standard procedure with smart payphones is that they periodically are polled from a central location to obtain data regarding the usage of the smart payphone, and to determine the coin revenue presently in the smart payphone. The smart payphones are polled via an incoming call that gets converted to an analog call at the ATA. That call can be originated from a modem connected to another ATA if a traditional poll is presently used, or via a direct SIP connection.

### SUMMARY

The Payphone Dial Tone Service System receives control and communication data via a VoIP communication connection that originates at an Analog Terminal Adapter and modem connected to the smart payphone. The Payphone Dial Tone Service System validates the smart payphone and originates a communication session to the appropriate carrier or Public Switched Telephone Network gateway. The Payphone Dial Tone Service System manages the ANI data to ensure proper terminal identification and AMA billing.

What is claimed as new and desired to be protected by Letters Patent of the United States is:

1. A system for providing payphone dial tone service to a plurality of smart payphones via a broadband communications link, comprising:
interface means for interconnecting said smart payphone, via a broadband communications link, exclusively to a predetermined payphone dial tone service system; and
connection means for establishing a communication session from said predetermined payphone dial tone service system to a gateway that is connected to a local exchange service provider that provides communication services to said called party.

2. The system for providing payphone dial tone service of claim 1 wherein said interface means comprises:
protocol conversion means for converting signals received from said smart payphone to broadband protocol signals; and
communication session initiation means, responsive to a user at said smart payphone initiating a call to a called party, for establishing a communication session over a broadband communications link from said smart payphone exclusively to a predetermined payphone dial tone service system.

3. The system for providing payphone dial tone service of claim 1 wherein said communication session initiation means comprises:
session initiation protocol means for transmitting control data containing the identity of the smart payphone and the identification of said called party to the connection means.

4. The system for providing payphone dial tone service of claim 3 wherein said connection means comprises:
authentication means, responsive to said transmitted control data, for determining a valid service identification for said smart payphone.

5. The system for providing payphone dial tone service of claim 3 wherein said connection means comprises:
service determining means for determining the type of service requested by said smart payphone; and
call processing means for establishing a communication session via the Internet to the Public Switched Telephone Network.

6. The system for providing payphone dial tone service of claim 5 wherein said connection means further comprises:
gateway selection means for selecting a gateway that is connected to the Internet to process said communication session.

7. The system for providing payphone dial tone service of claim 5 wherein said connection means further comprises:
session means for establishing a communication session using a Session Initiation Protocol.

8. The system for providing payphone dial tone service of claim 1 wherein said interface means comprises:
analog terminal adapter means connected to said smart payphone for interfacing said smart payphone with said broadband network.

9. The system for providing payphone dial tone service of claim 8 wherein said analog terminal adapter means comprises:
dial tone means for providing dial tone service to said smart payphone; and
telephone line emulation means for emulating a standard telephone line to said smart payphone.

10. The system for providing payphone dial tone service of claim 8 further comprising:
modem means connected to said analog terminal adapter means and responsive to a call initiation for initiating a communication session only to a predetermined payphone dial tone service system.

11. The system for providing payphone dial tone service of claim 8 further comprising:
modem means connected to said analog terminal adapter means and at least one additional piece of equipment including smart payphones and single line telephones, and other terminal devices, including: credit card terminals, security systems, and other data collection devices.

12. The system for providing payphone dial tone service of claim 1 wherein said connection means comprises:
connection splitting means for splitting media data generated by said smart payphone from control signaling generated by said smart payphone, comprising:
media data connection means for transmitting said media data directly from said interface means to said gateway; and
control signaling connection means for transmitting said control signaling exclusively to said connection means.

13. The system for providing payphone dial tone service of claim 1 wherein said connection means comprises:
carrier means for establishing a communication session from said predetermined payphone dial tone service system to a carrier for calls directed to a service provider.

14. The system for providing payphone dial tone service of claim 1 wherein said connection means comprises:
emergency services provider means for establishing a communication session from said predetermined payphone dial tone service system to an emergency services provider system via one of the Internet and a direct connection, for transmitting data that identifies a correspondence between the identity of the smart payphone and its physical location as well as establishing a call connection from said smart payphone to said emergency services provider system.

15. A method for providing payphone dial tone service to a plurality of smart payphones via a broadband communications link, comprising:
interconnecting said smart payphone, via a broadband communications link, exclusively to a predetermined payphone dial tone service system; and
establishing a communication session from said predetermined payphone dial tone service system to a gateway that is connected to a local exchange service provider that provides communication services to said called party.

16. The method for providing payphone dial tone service of claim 15 wherein said step of interconnecting comprises:
converting signals received from said smart payphone to broadband protocol signals; and
establishing, in response to a user at said smart payphone initiating a call to a called party, a communication session over a broadband communications link from said smart payphone exclusively to a predetermined payphone dial tone service system.

17. The method for providing payphone dial tone service of claim 15 wherein said step of establishing comprises:
transmitting control data containing the identity of the smart payphone and the identification of said called party to the predetermined payphone dial tone service system.

18. The method for providing payphone dial tone service of claim 17 wherein said step of establishing a communication session to a predetermined payphone dial tone service system comprises:
determining, in response to said transmitted control data, a valid service identification for said smart payphone.

19. The method for providing payphone dial tone service of claim 17 wherein said step of establishing a communication session to a gateway comprises:
determining the type of service requested by said smart payphone; and
establishing a communication session via the Internet to the Public Switched Telephone Network.

20. The method for providing payphone dial tone service of claim 19 wherein said step of establishing a communication session to a gateway further comprises:
selecting a gateway that is connected to the Internet to process said communication session.

21. The method for providing payphone dial tone service of claim 19 wherein said step of establishing a communication session to a gateway further comprises:
establishing a communication session using a Session Initiation Protocol.

22. The method for providing payphone dial tone service of claim 15 wherein said step of interconnecting comprises:
using an analog terminal adapter connected to said smart payphone for interfacing said smart payphone with said broadband network.

23. The method for providing payphone dial tone service of claim 22 wherein said step of using comprises:
providing dial tone service to said smart payphone; and
emulating a standard telephone line to said smart payphone.

24. The method for providing payphone dial tone service of claim 22 further comprising:
using a modem connected to said analog terminal adapter means and responsive to a call initiation for initiating a communication session only to a predetermined payphone dial tone service system.

25. The method for providing payphone dial tone service of claim 22 further comprising:
using a modem connected to said analog terminal adapter means and at least one additional piece of equipment including smart payphones and single line telephones, and other terminal devices, including: credit card terminals, security systems, and other data collection devices.

26. The method for providing payphone dial tone service of claim 22 wherein said step of establishing a communication session to a gateway comprises:
splitting media data generated by said smart payphone from control signaling generated by said smart payphone in said analog terminal adapter, comprising:
transmitting said media data directs from said analog terminal adapter to said gateway, and
transmitting said control signaling exclusively to said predetermined payphone dial tone service system.

27. The method for providing payphone dial tone service of claim 15 wherein said step of establishing a communication session to a gateway comprises:
establishing a communication session from said predetermined payphone dial tone service system to a carrier for calls directed to a service provider.

28. The method for providing payphone dial tone service of claim 15 wherein said step of establishing a communication session to a gateway comprises:
establishing a communication session from said predetermined payphone dial tone service system to an emergency services provider system via one of the Internet and a direct connection, for transmitting data that identifies a correspondence between the identity of the smart payphone and its physical location as well as establishing a call connection from said smart payphone to said emergency services provider system.
